(19) United States
(12) Patent Application Publication
(10) Pub. No.: US 2016/0132969 A1
(43) Pub. Date: May 12, 2016

(54) METHOD AND SYSTEM FOR OPTIMIZING PROCESSING OF INSURANCE CLAIMS AND DETECTING FRAUD THEREOF

(71) Applicant: Wipro Limited, Bangalore (IN)

(72) Inventors: Abhishek Gunjan, Nutan Nagar Gaya (IN); Sreevidya Khatravath, Ranga Reddy (IN)

(21) Appl. No.: 14/614,139

(22) Filed: Feb. 4, 2015

(30) Foreign Application Priority Data
Nov. 10, 2014 (IN) 5636/CHE/2014

(51) Int. Cl. G06Q 40/08

(52) U.S. Cl. CPC G06Q 40/08

(57) ABSTRACT

Embodiments of the present disclosure disclose a method for optimizing processing of insurance claims. The method comprises one or more steps performed by an insurance data processing apparatus. The method comprises examining completeness of information in an insurance application form to avail insurance claims for an insured patient. Then, the information contained in the insurance application form is segmented into at least one of medical data and behavioural data of the insured patient. Next, one or more diseases from the medical data into a medical group and behavioural parameters from the behavioural data are classified into a behavioural group. The classification is performed using predefined one or more ontologies comprising medical ontologies and behavioural ontologies. Then, a relevancy of the insurance claims associated to the insured patient is verified based on the classification of the one or more diseases and the behavioural parameters.

This application claims the benefit of Indian Patent Application No. 5636/CHE/2014 filed Nov. 10, 2014, which is hereby incorporated by reference in its entirety.

### FIELD

The present subject matter is related, in general to data processing system and more particularly, but not exclusively to a method and an insurance data processing apparatus for optimizing processing of insurance claims of the insured patient.

### BACKGROUND

Generally, insurance providers are related to providing insurance claims to an insurance policy holder. The insurance policy holder is called as insured patient when the insurance policy holder is under medical rest and claims for the health insurance claims from the insurance provider. Usually, the insurance providers process the health insurance claims for the insured patient based on details of the insured patient filled in an insurance claim form. Typically, the details of the insured patient include, but are not limited to, name, age, gender, details of disorders afflicted by the insured patient, details of the diseases suffered by the insured patient etc. which are filled in the insurance claim form. The insurance providers examine the completeness of the details of the insured patient in the insurance claim form. Also, the insurance providers examine whether all sufficient data and/or documents supplement to the details to the insured patient are disclosed. For example, the supplement data/documents like reports of the diseases suffered by the insured patient, X-ray reports, check-up report, health reports are provided to support the details the diseases or disorders mentioned in the insurance claim form. Upon examining the completeness of the details of the insured patient along with the supplement data/documents, the one or more insurance providers provide the health insurance claims to the insured patient. However, presently, the insurance providers do not validate the correctness of the details of the insured patient. Particularly, the one or more insurance providers do not validate whether the insured patient is actually suffering from those diseases or disorders which are mentioned in the insurance claim form. For example, the insured patient claims the health insurance claims by mentioning that the insured patient is suffering from the cardiac disorder and needs two months to recover from the disorder. The insured patient presents the details and the supplement data/documents falsely to avail the health insurance claims. However, in reality, the insured patient is holidaying or relaxing. In such case, the insurance providers undergo huge loss since the insurance providers do not validate the trueness, and correctness of the details in the insurance application form.

Further, the insurance providers undergo loss if the insured patient stays out-of-work i.e. recovery period from the disorder/diseases. Specifically, the one or more insurance providers need to provide the health insurance claim till the insured patient is under the medical rest. For example, the insured patient mentions that the insured patient has to stay under medical rest for two months. Then, the insurance providers must provide the health insurance claims for the entire two months. The insurance providers do not check whether the insured patient actually needs two months of medical rest, which in turn can cause huge loss to the insurance providers. Particularly, there is no aspect of predicting duration for which the insured patient will be under the medical rest to reduce the losses of the insurance providers.

The present methods do not predict authenticity of the health insurance claims for the insured patient based on medical conditions and behavioural state of the insured patient.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein is a method for optimizing processing of insurance claims. The method comprises one or more steps performed by an insurance data processing apparatus. First step of the method comprises examining completeness of information in an insurance application form to avail insurance claims for an insured patient. Second step of the method comprises segmenting the information contained in the insurance application form into at least one of medical data and behavioural data of the insured patient. Third step of the method comprises classifying one or more diseases from the medical data into a medical group and behavioural parameters from the behavioural data into a behavioural group. The classification is performed using predefined one or more ontologies. The predefined one or more ontologies comprises medical ontologies and behavioural ontologies. Last step of the method comprises verifying a relevancy of the insurance claims associated to the insured patient based on the classification of the one or more diseases and the behavioural parameters. In an embodiment, the method further comprises alerting incompleteness of the information in the insurance application form. The method further comprises evaluating severity level of the one or more diseases suffering by the insured patient, stamina level of the insured patient, and immunity level of the insured patient using at least one of the medical ontology and historical medical information of the insured patient. The method further comprises evaluating recovery period of the insured patient using at least one of the predefined one or more ontologies, historical behavioural information and the historical medical information of the insured patient. The method further comprises retrieving behavioural parameters from one or more data sources selected from at least one social blogs, social media, Customer Relationship Management (CRM) based data sources associated to an insurance provider, data sources associated to medical service providers and data sources related to behavioural examiner. The method further comprises identifying fraud by performing two steps. First step comprises retrieving reports comprising at least one of the information, the medical data, the behavior data, historical medical information, behavioural parameters, and historical information related to availing of insurance claims. Second step comprises mapping the reports to the at least one of the classification of the one or more diseases and the behavioural parameters and the predefined one or more ontologies to examiner the correctness of availing of the insurance claims.

In an aspect of the present disclosure, an insurance data processing apparatus for optimizing processing of insurance claims is disclosed. The insurance data processing apparatus comprises a processor and a memory communicatively coupled to the processor. The memory stores processor-executable instructions, which, on execution, cause the processor to perform one or more steps. The processor is configured to examine completeness of information in an insurance application form to avail the insurance claims for an insured patient. The processor is configured to segment the information contained in the insurance application form into at least one medical data and behavioural data of the insured patient. The processor is configured to classify one or more diseases from the medical data into a medical group and behavioural parameters from the behavioural data into a behavioural group. The classification is performed using predefined one or more ontologies comprising medical ontologies and behavioural ontologies. The processor is configured to verify a relevancy of the insurance claims associated to the insured patient based on the classification of the one or more diseases and the behavioural parameters.

In another aspect of the present disclosure, a non-transitory computer readable medium for optimizing processing of insurance claims is disclosed. The non-transitory computer readable medium includes instructions stored thereon that when processed by a processor causes an insurance data processing apparatus to perform acts of examining completeness of information in an insurance application form to avail the insurance claims for an insured patient; segmenting the information contained in the insurance application form into at least one of medical data and behavioural data of the insured patient; classifying one or more diseases from the medical data into a medical group and behavioural parameters from the behavioural data into a behavioural group, said classification is performed using predefined one or more ontologies comprising medical ontologies and behavioural ontologies; and verifying a relevancy of the insurance claims associated to the insured patient based on the classification of the one or more diseases and the behavioural parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an environment for processing insurance claims in accordance with some embodiments of the present disclosure;

FIG. 2 illustrates a block diagram of an insurance data processing apparatus for optimizing processing of insurance claims of an insured patient in accordance with some embodiments of the present disclosure;

FIG. 3 illustrates a block diagram of data retriever for retrieving information related to an insured patient in accordance with some embodiments of the present disclosure;

FIG. 4 illustrates a block diagram of recommendation module to recommend one or more supplement data required for processing insurance claims in accordance with some embodiments of the present disclosure;

FIG. 5 illustrates a block diagram of output module to provide visualization of processing of insurance claims in accordance with some embodiments of the present disclosure;

FIG. 6 illustrates a flowchart of method for optimizing processing of the insurance claims for the insured patient in accordance with an embodiment of the present disclosure; and

FIG. 7 illustrates a block diagram of an exemplary insurance data processing apparatus for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method for optimizing processing of insurance claims for an insured patient. The processing of insurance claims is optimized by an insurance data processing apparatus which possess intelligence for processing the insurance claims in real-time. The processing of insurance claims is optimized by examining correctness of information provided in an insurance application form. Then, the information contained in the insurance application form is segmented into medical data and behavioural data. Upon segmenting, diseases from the medical data and behavioural parameters from behavioural data are classified into different groups using ontologies. The groups comprise medical group and behavioural group which classified using medical ontologies and behavioural ontologies respectively. Then, the relevancy of insurance claims claimed for the insured patient is validated and verified using the classification. The relevancy is validated and verified in order to determine authenticity of the insurance claims for the insured patient. Such way of authentication reduces the fraudulent usage of insurance claims. Further, the method evaluates an extent of insurance claims that the insured patient can avail. Additionally, the method determines a period for which the insured patient is prolonged from out-of-work which refers to duration for recovering from the diseases or disorder. The period is determined using the classification and liabilities of the insured patient.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

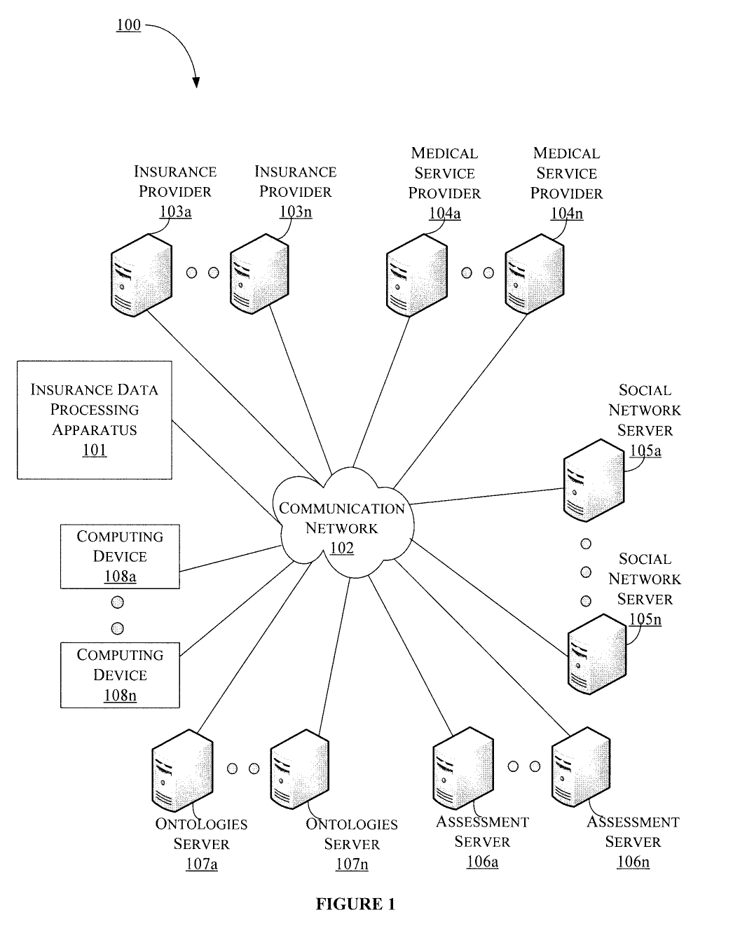

FIG. 1 illustrates environment 100 for processing insurance claims in accordance with some embodiments of the present disclosure. The network architecture 100 comprises an insurance data processing apparatus 101, one or more insurance providers 103a, . . . , 103n (collectively referred to 103), one or more medical service providers 104a, . . . , 104n (collectively referred to 104), one or more social network servers 105a, . . . , 105n (collectively referred to 105), one or more assessment servers 106a, . . . , 106n (collectively referred to 106), one or more ontologies servers 107a, . . . , 107n (collectively referred to 107) and one or more computing devices 108a, . . . , 108n (collectively referred to 108).

The insurance data processing apparatus 101 may be implemented in a variety of computing systems, such as a laptop computer, a desktop computer, a notebook, a workstation, a mainframe computer, a server, a network server, and the like. In an embodiment, the insurance data processing apparatus 101 communicates with the one or more insurance providers 103, the one or more medical service providers 104, the one or more social network servers 105, the one or more assessment servers 106, the one or more ontologies servers 107 and the one or more computing devices 108 over a communication network 102. The insurance data processing apparatus 101 is related to optimizing processing of insurance claims for an insured patient. The processing of insurance claims for the insured patient is optimized by retrieving one or more reports related to the insured patient from the one or more insurance providers 103, the one or more medical service providers 104, the one or more social network servers 105, and the one or more assessment servers 106. Each of the one or more insurance providers 103, the one or more medical service providers 104, the one or more social network servers 105, the one or more assessment servers 106 and the one or more ontologies servers 107 include, but is not limited to, a server, a network server, a node, a mainframe computer and the like.

Each of the one or more insurance providers 103 maintains reports of insured patient. In an embodiment, the reports of insured patient include, but are not limited to, details of the insured patient, details of insurance policies covered for the insured patient, money bills, details of one or more diseases afflicted by the insured patient, medicinal prescriptions, reports on diagnosis, check-up reports, X-ray reports, ultrasound reports, radiography reports, historical insurance claim information, historical medical information and other related reports. The details of the insured patient include, but are not limited to, name, age, gender, date of birth, contact number, temporary address, permanent address, and family details etc. The money bills are related to debt towards medical treatments, medicines, prescriptions, check-up reports, diagnosis and other related conducts. The historical insurance claim information includes, but is not limited to, number of times the insurance claims availed by the insured patient in past and extent of insurance claims availed by the insured patient in past. The historical medical information includes, but is not limited to, medical history of both the insured patient and family of the insured patient. The medical history refers to one or more diseases, health conditions and other medical disorders afflicted by both insured patient and members of the family. A person skilled in art should understand that the reports of the insured patient include all the other details related to insured patient which are usually required to be maintained by existing insurance providers for processing the insurance claims.

Each of the one or more medical service providers 104 maintains medical reports of the insured patient. The medical reports of the insured patient include, but are not limited to, personal details of the insured patient, medical bills, premedical history details of the insured patient, historical medical information of both insured patient and the family, side effects and/or allergenic details of the insured patient, medicinal prescriptions of medical practitioners for the insured patient, X-ray reports, details of diagnosis, Medical Records (MR) of the insured patient, Computed Tomography (CT) reports of the insured patient, check-up reports, one or more diseases afflicted by the insured patient, health conditions of the insured patient, one or more disorders of the insured patient, and reports of insured patient assessed by an assessment specialists. The personal details of the insured patient include, but are not limited to, name, age, gender, liabilities, stamina level, immunity level, life style, and nature of job, habitat, and work environment of the insured patient. The medical bills are related to debt towards medical treatments, medicines, prescriptions, check-up reports, diagnosis and other related conducts. The premedical history details refer to medical conditions of the insured patient prior to procuring of medical treatments. The medical practitioners include, but are not limited to, medical specialists, doctors, health specialists etc. The assessment specialists refer to specialists who assess the medical, health and other related conditions of the insured patient. A person skilled in art should understand that the medical reports of the insured patient include all the other medical details related to medical and/or health conditions of the insured patients which are usually required to be maintained by existing medical service providers.

Each of the one or more social network servers 105 is associated to social networking sites, social networking blogs and social media. In an embodiment, the one or more social network servers 105 are used to analyze on behavior of the insured patient. For example, during medical review, the insured patient shows behavior having sickness. Now, assuming the insured patient has updated a status in at least one of the one or more social networking sites that the insured patient is feeling improvement in health. Then, by referring to the status in the one or more social network servers 105, correctness of the behavior can be checked or verified. Also, by referring to the social blogs the relevancy can be verified to determine whether the insured patient is actually applicable for claiming the insurance claims. Additionally, by analyzing behavior from the social media or social blogs, the extent of the insurance claims applicable for the insured patient may be determined.

Each of the assessment servers 106 stores reports and/or records related to condition which includes, but is not limited to, medical condition, health condition and behavior condition of the insured patient. The reports and/or records related to condition of the insured patient are created upon assessing the insured patient. The insured patient is assessed by a specialist who includes, but is not limited to, health assessor, medical practitioners, nurses, behavior examiners, health examiners, health inspectors. In an embodiment, an insurance claim examiner and/or an insurance claim approver who is related to examine and/or approve the claim may also assess the insured patient with respect to medical and behavior conditions. The reports or records created by the insurance claims examiner/approver can be provided to the insurance providers for storing.

In an embodiment, each of the one or more ontologies servers 107 is associated to maintain predefined ontologies comprising predefined medical ontologies and predefined behavioural ontologies. The medical ontologies refer to relationship between different types of diseases and genes of all kinds of patients. Such relationship helps in understanding anatomy of the one or more diseases. Additionally, the medical ontologies refer to factors causing the diseases, severity factors of the diseases and symptoms of the diseases. Further, the medical ontologies maintain different behaviors which are found in the one or more diseases. In one implementation, the medical ontologies contain observation in a dictionary form. The observation pertains to specific diseases which help to understand the cause of the disease and severity of the diseases which causes the insured patient to prolong from out-of-work. The behavior ontologies refer to relationship of different behavior with one another of different patients in different circumstances. The behavioural ontologies contain different features and attributes which symbolizes a particular behavior. The behavioural ontologies contain observation associated to symptoms of the behavior. Also, the behavioural ontologies contain observation of different conditions and kinds of people in which the different behavior occurs. Each of the one or more ontologies servers 107 comprises ontologies generator to generate the medical ontologies and the behavioural ontologies. A person skilled in art should understand that the ontologies comprise all the kinds of medical ontologies and behavioural ontologies which are usually required to analyze the medical condition and behavioural state of a person.

Each of the one or more computing devices 108 include, but are not limited to, a desktop computer, a portable computer, a mobile phone, a handheld device, a workstation. In an embodiment, the one or more computing devices 108 are used for inputting an insurance application form of an insured patient. Also, the one or more computing devices 108 are used to fill an online insurance application form. For example, consider an insured patient is hospitalized and the insured patient wants to avail the insurance claims. Then, an insurance application form is filled out with all the necessary information related to the insured patient and inputted using the one or more computing device 108. Likewise, an online insurance claim form is filled with the information of the insured patient. Then, the insurance application form is provided to the insurance data processing apparatus 101 for validation and verification to determine the authenticity of the insurance claims for the insured patient. In an embodiment, each of the one or more computing devices 108 comprises a user interface (not shown) to display one or more insurance processing details. The one or more insurance processing details include, but are not limited to, the information filled out in the insurance application form, medical information and behavioural information of the insured patient, details of the one or more diseases afflicted by the insured patient, details of the insurance policy of the insured patient, historical information related to availing of insurance claims in past, and report on factors causing to avail the insurance claims.

In an embodiment, the user interface of the one or more computing devices 108 provides an alert upon determining incompleteness of the information in the insurance application form. The user interface of the one or more computing devices 108 provides alert regarding requirement of additional data and/or document supplement to the information for processing the insurance claims for the insured patient. In an embodiment, one or more data and/or document supplement to the information can be inputted through user interface of the one or more computing devices 108. Also, feedback and/or updated information may be inputted through the user interface of the one or more computing devices 108 for processing the insurance claims. In an embodiment, the user interface of the one or more computing devices 108 displays number of days required for the insured patient to recover from the disease or disorder. In such way, the number of days for which the insured patient is prolonged from out-of-work is intimated. For example, assuming the insured patient is suffering from a cardiac related disorder. Considering, the insured patient requires medical rest for one month. Therefore, a period of one month required by the insured patient under medical rest is intimated to both the insurance provider 103 and company in which the insured patient is working In this way, the insurance provider 103 and the work company are aware of the number of days for which the insured patient is out-of-work. Also, the insurance provider 103 is aware of extent of insurance claims applicable to the insured patient. For example, the insurance provider 103 is aware that the insurance claims can be availed only for one month by the insured patient. The user interface of the one or more computing devices 108 provides alerts upon determining fraudulent activity of the insured patient in claiming the insurance claims. Additionally, one or more factors causing the fraud are intimated on the user interface of the one or more computing devices 108. For example, considering the insured patient claims for availing insurance claims towards medical rest due to cardiac disorder. However, assuming, the insured patient has updated the status on one of the one or more social networking blogs stating that the insured patient is on trip during the same time as the insured patient claims for insurance claims. In such a way, a fraud is identified by analyzing inconsistency between the information in the insurance application form and information in the social networking blogs. Further, a false claim can be detected by analyzing the inconsistency. In an embodiment, the user interface of the one or more computing devices 108 provides a track of stage of insurance claims processing. Particularly, every stage of insurance claim processing can be traced or tracked to identify duration required for approving the insurance claims for the insured patient.

In one implementation, the insurance data processing apparatus 101 acts as computing device 108 also. Therefore, the insurance application form for processing the insurance claims for the insured patient is directly received by the insurance data processing apparatus 101.

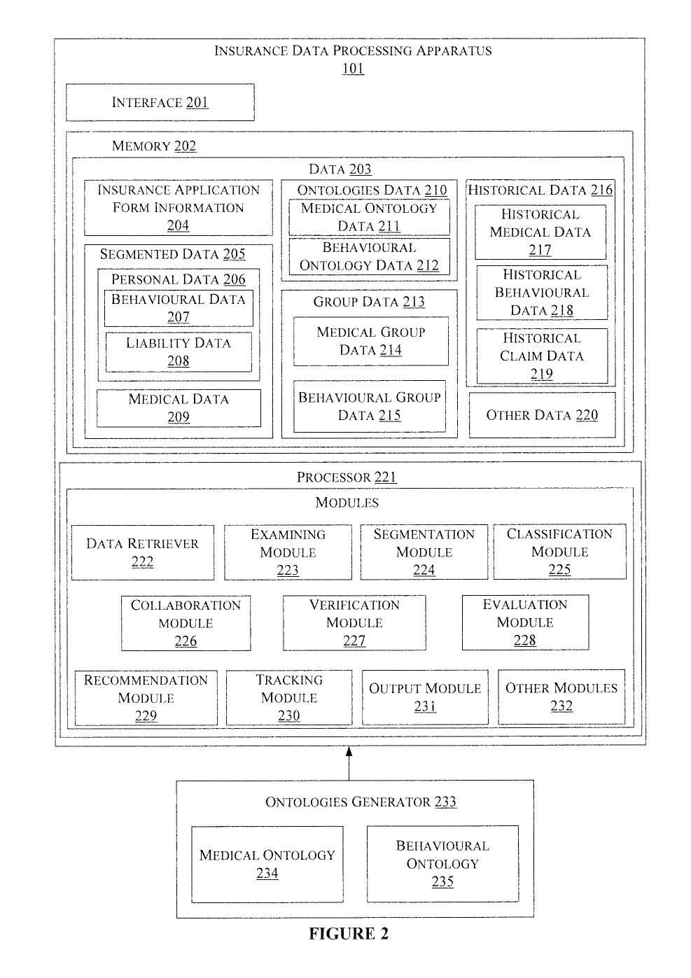

FIG. 2 illustrates a block diagram of an insurance data processing apparatus 101 for optimizing processing of insurance claims for the insured patient in accordance with some embodiments of the present disclosure.

In one implementation, the insurance data processing apparatus 101 includes a central processing unit (“CPU” or “processor”) 221, an interface 201 and a memory 202. The processor 221 may comprise at least one data processor for executing program components and for executing user- or system-generated insurance application form filled with the information of the insured patient. The interface 201 is coupled with the processor 221. The data like information including insurance policy, the medical and behavioural information of the insured patient are received by the insurance data processing apparatus 101 through the interface 201. In an embodiment, the information including insurance policy, the medical and behavioural information of the insured patient are received from the one or more insurance providers 103, the one or more medical service providers 104, the one or more social network servers 105, the one or more assessment servers 106 and the one or more computing devices 108. The memory 202 is communicatively coupled to the processor 221. The memory 202 stores processor-executable instructions to optimize processing of insurance claims for the insured patient. In one implementation, the memory 202 comprises data 203 required for processing the insurance claims for the insured patient. In one example, the data 203 may be stored within the memory 202. In one implementation, the data 203 may include, for example, insurance application form information 204, segmented data 205, ontologies data 210, group data 213, historical data 216 and other data 220.

In one implementation, the insurance application form information 204 refers to information filled-out in the insurance application form. The information contained in the insurance application form information 204 is related to the insured patient claiming for the insurance claims. The information 204 in the insurance application form may comprise the details of the insured patient, the details of insurance policies covered for the insured patient, the medical bills, the details of one or more diseases afflicted by the insured patient, the medicinal prescriptions, blood group details, side effects and/or allergenic details of the insured patient, the reports on diagnosis, and the check-up reports. The information 204 may also include supplement data and/or document which includes, but is not limited to, the X-ray reports, the ultrasound reports, the radiography reports, the Computed Tomography (CT) reports, the Medical Report (MR) reports etc. The information in the insurance application form may also be mentioned with the historical insurance claim information, and historical medical information of both the insured patient and the family. In one implementation, the information 204 may be in one or more formats which include, but are not limited to, text, image, audio, video, document, digital format, and template formats. In an embodiment, the insurance data processing apparatus 101 is capable of receiving the information and supplement data/documents in any of the above mentioned formats. A person skilled in art should understand that the insurance application form of the insured patient may include any other details related to the insured patient which are usually required to be mentioned for claiming the insurance claims.

In an embodiment, the segmented data 205 comprises personal data 206 and medical data 209. Particularly, the information from the insurance application form is segmented into personal data 206 and medical data 209. The personal data 206 comprises behavioural data 207 and liability data 208 related to the insured patient. The personal data 206 comprises the details of the insured patient which include, but are not limited to, name, age, gender, work environment, work industry, medical history of both the insured patient and the family, level of stamina, and level liabilities etc. of the insured patient. The personal data 206 is used for medical analysis and behavior analysis of the insured patient. In an embodiment, the personal data 206 is used for identifying cause of the disorder and/or illness of the insured patient. In an embodiment, the cause of the disorders and/or illness may be due to excessive debt, excessive liabilities etc. which are included in the personal data 206. For example, traumas like hypertension, insomnia, cardiac related disorder etc. may be caused due to excessive debt, liabilities, stress, strain suffered by the insured patient. Such causing factors are analyzed to identify the cause of the disorder and/or illness of the insured patient.

The behavioral data 207 refers to one or more behavioural parameters which include, but is not limited to, activities, behavior, conducts, actions, performances of the insured patient. In an embodiment, the behavioural data 207 is analyzed using the behavioural ontologies referred from the one or more ontologies server 107. In one example, the behavior of the insured patient is analyzed from the video streams. In one implementation, the one or more behavioural parameters are retrieved from one or more data sources over the communication network 102. In an exemplary embodiment, the one or more data sources include, but are not limited to, social network servers 105 related to social blogs, and social media. The one or more data sources also includes, but are not limited to, Customer Relationship Management (CRM) based data sources associated to the one or more insurance providers 103, data sources associated to the one or more medical service providers 104, and the one or more assessment servers 106 associated with behavioural examiner/inspector. In such a way, the insurance data processing apparatus 101 provides 360 degree view of the insured patient to the one or more insurance providers 103 for processing the insurance claims with total accuracy. Additionally, the behavioural data 207 aids the one or more insurance providers 103 to analyze the insured patient in order to provide the insurance claims as required for the insured patient. In such a way, excessive availing of the insurance claims and/or the fraud is reduced which in turn benefits the one or more insurance providers 103. In one implementation, the behavioural data 207 is used by the medical practitioners and other specialists for conducting training sessions for the insured patient to overcome the disorder and/or illness. Such conducts of training sessions may help in reducing the extent of availing of insurance claims by the insured patient and also the number of days from out-of-work. In one implementation, the behavioural data 207 assists to identify incomplete information which is required for processing the insurance claims.

The liability data 208 related to the insured patient is used for predicting the fraud. Also, the liability data 208 is used for identifying cause for prolongation from out-of-work.

The medical data 209 pertains to type of diseases suffered by the insured patient, medicines, prescriptions, medial reports, radiography reports, medical history of both the insured patient and the family. In one implementation, the medical data 209 of the insured patient is analyzed based on the information provided in the insurance application form. In an embodiment, the medical data 209 of the insured patient is evaluated using the medical ontologies from the one or more ontologies servers 107. In one example, the personal data 206 is used for creating the medical data 209.

The ontologies data 210 relates to data retrieved from the one or more ontologies servers 107. The ontologies data 210 comprises medical ontology data 211 and behavioural ontology data 212. In one implementation, the medical ontology data 211 pertains to the medical ontology 234 generated by an ontologies generator 233 of the one or more ontologies servers 107. The behavioural ontology data 212 pertains to the behavioural ontology 235 generated by the ontologies generator 233 of the one or more ontologies servers 107.

In an embodiment, the group data 213 pertains to classification of the one or more diseases and the behavioural parameters. The group data 213 comprises medical group data 214 and behavioural group data 215. The medical group data 214 contains classification of the one or more diseases which are acquired from the medical data 209. The behavioural group data 215 contains classification of the one or more behavioural parameters which are acquired from the behavioural data 207.

The historical data 216 comprises historical medical data 217, historical behavioural data 218 and historical claim data 219. The historical medical data 217 refers to medical history of both the insured patient and the family of the insured patient. The historical behavioural data 218 refers to behavioural history of the insured patient. For example, behavioral history refers to what kind of behavior was presented by the insured patient in a particular circumstance. The historical claim data 219 refers to number of times and extent of insurance claims been availed by the insured patient in past.

In one embodiment, the aforementioned data 203 may be organized using data models, such as relational or hierarchical data models. The other data 220 may be used to store data, including temporary data and temporary files, generated by modules for performing the various functions of the insurance data processing apparatus 101. In an embodiment, the data 203 are processed by the modules of the insurance data processing apparatus 101. The modules implemented by the processor 221 of the insurance data processing apparatus 101.

In one implementation, the modules may include, for example, data retriever 222, examining module 223, segmentation module 224, classification module 225, collaboration module 226, verification module 227, evaluation module 228, recommendation module 229, tracking module 230, and output module 231. The insurance data processing apparatus 101 may also comprise other modules 232 to perform various miscellaneous functionalities of the insurance data processing apparatus 101. It will be appreciated that such aforementioned modules may be represented as a single module or a combination of different modules.

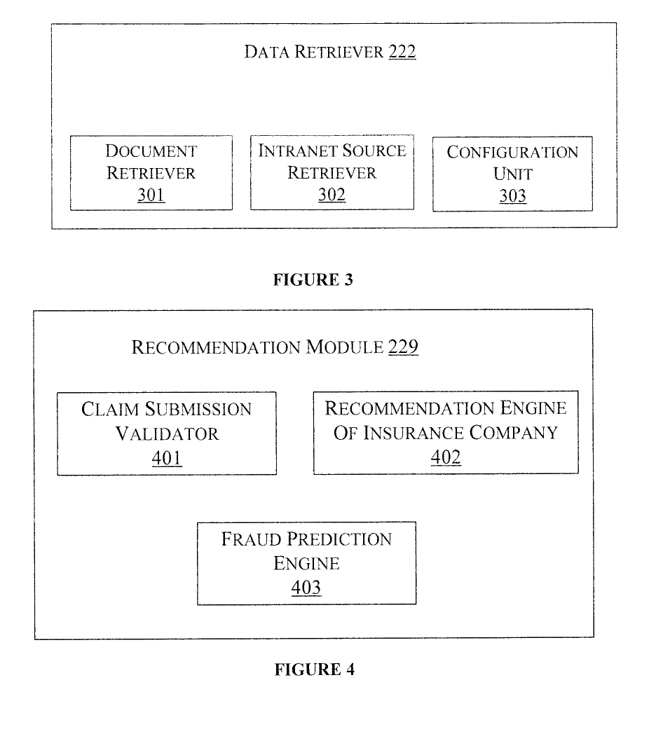

The data retriever 222 retrieves the information related to the insured patient claiming for the insurance claims. The data retriever 222 retrieves the information from the one or more insurance providers 103, the one or more medical service providers 104, the one or more social network servers 105 and the one or more assessment servers 106. In one implementation, the data retriever 222 retrieves the information along with supplement data and/or documents inputted using the one or more computing devices 108. The data retriever 222 comprises Structured Query Language (SQL) and Not Only Structured Query Language (NoSQL) units to retrieve the information and the supplement data and/or documents in any types of formats mentioned above. Additionally, the data retriever 222 is configured with a query builder (not shown) and a query analyzer (not shown). The query builder is associated with retrieving updated information of the insured patient. For example, updated information and/or an updated reports supplement to the information are retrieved by the query builder. The query analyzer analyzes the updated information to monitor the claim process with the updated information. In an exemplary embodiment, parts of the information may be added and/or removed from the insurance application form using the query builder and the query analyzer. The data retriever 222 comprises a document retriever 301, an intranet source retriever 302, and configuration unit 303 as illustrated in FIG. 3.

The document retriever 301 retrieves the insurance application form from the one or more computing devices 108 in a format including, but is not limited to, text, image, video, and audio. The document retriever 301 is capable of converting the information and the supplement data/documents to the digitized format by an Optical Character Recognition (OCR). For example, the medicinal prescription or ultrasound report is inputted as image which is retrieved by the document retriever 301. The document retriever 301 converts the image into digitized format by the OCR. In an embodiment, hand written information is also digitized by the OCR.

The intranet source retriever 302 retrieves the reports or records from the one or more insurance providers 103, the one or more medical service providers 104, the one or more social network servers 105 and the one or more assessment servers 106 over the communication network 102. The retrieved reports or records are digitized using OCR by the intranet source retriever 302. For example, the details of the insurance policy of the insured patient are retrieved from the Customer Relationship Management (CRM) associated to the one or more insurance providers 103. In an embodiment, the intranet source retriever 302 converts the reports received from the assessor or field investigator or health examiner or behavioural examiner into OCR format. In one example, the video of the insured patient's interaction with the insurance provider officials are retrieved by the document retriever 301.

The configuration unit 303 is configured to extract the missing information of the insured patient from the one or more social network servers 105.

Referring back to FIG. 2, the examining module 223 examines the completeness of the information in the insurance application form to avail the insurance claims for the insured patient. For example, each field of the insurance application form is examined to check the completeness of the information. In one implementation, the examining module 223 examines the correctness of the information in the insurance application form. Additionally, the examining module 223 identifies the missing information in the insurance application form and prompts the output module 232 to alert the incompleteness of the information.

The segmentation module 224 is configured to segment the information from the insurance application form into the personal data 206 comprising the behavioural data 207 and the liability data 208, and the medical data 209. In an embodiment, the segmentation module 224 performs the segmentation based on functions configured dynamically by the insurance data processing apparatus 101. In one implementation, the segmentation is performed based on functions configured by a system administrator. The segmentation module 224 determines the missing behavioural information which is required for processing the insurance claims.

The classification module 225 classifies the one or more diseases from the medical data 209 into the medical group 214 and the behavioural parameters from the behavioural data 207 into the behavioural group 215. In one example, the classification module 225 classifies the one or more diseases and the behavioural parameters into different classification models. Each of the models process the segmented data created by the segmentation module 224. In an embodiment, the classification module 225 classifies the one or more diseases and the behavioural parameters using the predefined one or more ontologies 234 comprising the medical ontologies 235 and the behavioural ontologies 236. The classification module 225 is configured to classify both the structured and unstructured data using the machine learning and natural language processing engines. Additionally, in one example, the classification module 225 is configured to classify text, image, speech, and video stream data etc. into models.

The collaboration module 226 collaborates each of the classification models of the one or more diseases and the behavioural parameters of the insured patient. Then, the collaboration module 226 creates a multi-dimensional collaborative model for each of the classification models. The multi-dimensional collaborative model provides correlation between the different classification models. The multi-dimensional collaborative model provides multiple dimensional pictures of the one or more diseases and the behavioural parameters. In one implementation, the collaboration module 226 provides the multi-dimensional collaborative model to the user interface of the one or more computing devices 108 through the output module 232. Additionally, the collaboration module 226 processes the multi-dimensional collaborative model based on the updated information which is receives as a feedback.

The verification module 227 is configured to verify a relevancy of the insurance claims associated to the insured patient based on the classification of the one or more diseases and the behavioural parameters. Particularly, the verification module 227 determines the authenticity of the insurance claims as claimed for the insured patient. For example, the verification module 227 verifies whether the insured patient is actually applicable for availing the insurance claims based on the medical and behavioural parameters of the insured patient. Additionally, verification module 227 verifies whether the number of days required for recovering from the diseases/disorder is correct. Such verification determines the extent of the insurance claims for the insured patient reducing the fraud and excessive use of the insurance claims. A result of the relevancy is intimated to the user interface of the one or more computing devices 108 through the output module 232. For example, a result whether the insured patient is authenticated to avail the insured patient is intimated to the user interface of the one or more computing devices 108 and the one or more insurance providers 103.

The evaluation module 228 evaluates one or more criteria which includes, but is not limited to, severity level of the one or more diseases suffered by the insured patient, stamina level of the insured patient, and immunity level of the insured patient by using the medical ontology 234 and the historical medical information 217 of the insured patient. The evaluation module 228 evaluates a recovery period of the insured patient or out-of-work state of the insured patient. The recovery period or the out-of-work state is evaluated using the predefined medical ontologies 234 and behavioural ontologies 235, the historical behavioural information 218 and the historical medical information 217 of the insured patient. Such evaluation results are provided to the user interface for viewing and the one or more insurance providers by the output module 231.

The recommendation module 229 recommends one or more additional supplement data related to the insured patient required for processing the insurance claims. The recommendation module 230 recommends insurance claims approvers at multiple stages to retrieve missing information related to the insured patient. Further, the recommendation module 229 retrieves micro level information of the insured patient based on the historical medical/behavioural data of other insured patients and the insured patient.

The recommendation module 229 uses multi-dimensional collaborative models to perform evaluate conclusions from data 203 for processing the insurance claims for the insured patient.

Further, the recommendation module 229 performs prioritization of insurance claims by predicting severity index of the insurance claims. Also, the recommendation module 229 performs prioritization of processing of insurance claims based on the historical claim data 219. In one implementation, the recommendation module 229 recommends the actual duration required for the insured patient to recover from the diseases or disorders. In an embodiment, the recommendation module 229 prioritizes the processing of the insurance claims for the insured patient. The prioritization is performed using the medical condition and behavioural parameters of the insured patient. In one example, the video and/or voice data of the insured patient is analyzed to evaluate the behavior and medical condition of the insured patient. The evaluation of the behavior and medical condition of the insured patient prioritizes the insurance claim processing. Additionally, the recommendation module 229 prioritizes the processing of the insurance claims based on the updated information received as a feedback from the user interface of the one or more computing devices 108. The recommendation module 229 prioritizes the processing of the insurance claims based on the updated information received from the one or more insurance providers 103, the one or more medical service providers 104, the one or more social network servers 105 and the one or more assessment servers 106.

The recommendation module 229 comprises claim submission validator 401, recommendation engine of the insurance company 402, and fraud prediction engine 403 as illustrated in FIG. 4.

The claim submission validator 401 performs validation using the domain knowledge learned from the historical data. In an embodiment, the claim submission validator 401 is configured to perform validation of the information provided by the insured patient in the insurance application form. Particularly, the claim submission validator 401 performs domain level validation which refers to presence of sufficient data on medical information and behavioural information. In one example, claim submission validator 401 also consider the historical claim data 219 of the insured patient on how frequently the insured patient has availed claim in past. The historical claim data 219 is collated to validate the claim. The claim submission validator 401 performs series of regression on the data 203 to evaluate a validation score.

The recommendation engine of the insurance company 402 regress through data 203 to evaluate duration of insurance claim which insured patient wants to avail. The recommendation engine of the insurance company 402 recommends the medical information and behavior information to the insurance company. In such a way, the insurance company can be aware of relevant training sessions which can be provided to the insured patient in order to reduce the out-of-work duration. For example, recommendation engine of the insurance company 402 recommends certain measures and exercises to reduce out-of-work duration by using the interview video of the insured patient after the claim is availed and the insured patient is back to work.

In an embodiment, the fraud prediction engine 403 identifies the fraud is identified by retrieving reports which comprises the information 204, the medical data 209, the behavioural data 207, the historical medical information 217, behavioural parameters related data, and historical information related to availing of insurance claims 219. Then, the fraud prediction engine 403 maps the retrieved reports to the classification of the one or more diseases and the behavioural parameters and the predefined one or more ontologies. Based on mapping, the correctness of availing of the insurance claims is examined to identify the fraud. For example, considering the insured patient is suffering from the cardiac disorder. The insured patient claims the extent of insurance claims as two lakh rupees and two months required for being out-of-work. The extent of insurance claims and duration required for being out-of-work are mapped to the classification of the one or more diseases and the behavioural parameters and the predefined ontologies. That is, the claimed two lakh rupees of insurance claims and two months for being out-of-work are verified to determine the correctness of the claims. Then, the verification is performed to determine applicability of the insurance claims as per the classification of the one or more diseases, the behavioural parameters and the predefined ontologies. In an embodiment, the fraud prediction engine 403 identifies the fraud based on the evaluation of the behavior and medical condition. Additionally, the fraud prediction engine 403 uses the classification models and the ontologies 233 for determining the fraud.

In one implementation, the fraud prediction engine 403 computes the liability level on the insured patient based on the classification models created by the classification module 225. Such computation of the liability level on the insured patient aids to predict fraud and reduce timeline of the processing the insurance claims.

Referring back to FIG. 2, the tracking module 230 traces or tracks various stages or levels of the processing the insurance claims. For example, considering the insurance application form is under verification of the insurance approver which is level 3. Then, the tracking module 230 tracks the processing level of the insurance claims to be level 3 under claim approver. The tracing module 230 provides the tracking details to the output module 231 to display the track of the processing of the insurance claims on the user interface.

The output module 231 is associated with a visualization engine (not shown). In an embodiment, the output module 231 provides a 360 degree view of the insured patient in terms of health condition, behavioural information and type of insurance policy covered and number of times the insured patient has availed claim.

The output module 231 provides the 360 degree of the insured patient claims to the user interface of the one or more computing devices 108, the one or more insurance providers 103 and the one or more medical service providers 104.

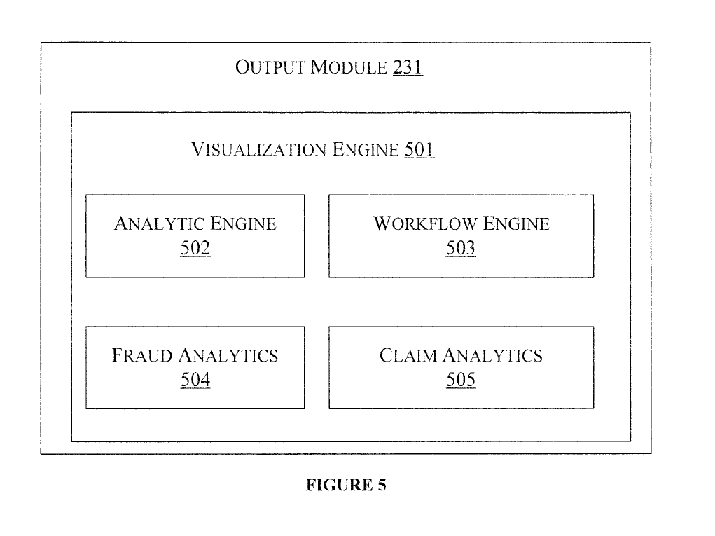

The output module 231 comprises a visualization engine 501 as illustrated in FIG. 5. The visualization engine 501 displays effective timeline for availing the insurance claims evaluated by the evaluation module 228. The visualization engine 501 provides each of details which include, but are not limited to, the information 204, the medical data 209, the behavioural data 207, the liability data 208, the classification of the one or more diseases and the behavioural parameters, details of the insurance policy of the insured patient, historical information related to availing of insurance claims, report of the insurance claims being availed for the insured patient and report on factors causing to avail the insurance claims to the user interface of the one or more computing devices 108, the one or more insurance providers 103 and the one or more medical service providers 104 for viewing.

The visualization engine 501 displays the detection of the fraud. The visualization engine 501 provides a multi-dimensional cluster which can be drilled down on root cause of the fraud. Also, the visualization engine 501 displays the reasons as to why the insurance claims processing is rejected.

In an embodiment, the visualization module 501 comprises analytic engine 502, workflow engine 503, fraud analytics 504 and claim analytics 505.

The analytical engine 502 provides an analytical view of the insured patient and insurance claims been processed. The analytic engine 502 provides the reasons for extending the processing and/or approval of the insurance claims for the insured patient. The analytic engine 502 displays behavior and disease in advance of processing the insurance claims which helps in approving or rejecting the availing of the insurance claims by the insured patient. The analytic engine 502 comprises templates which are used to configure new dashboard for visualization.

The workflow engine 503 provides a 360 degree view of the claim processing status. The workflow engine 503 enables to visualize the end to end workflow of the claim. The workflow engine 503 displays details of the tracking of the processing of the insurance claims. Particularly, the workflow engine 503 provides visualization of each stage of the claim processing. For example, the workflow engine 503 displays information of the stage where the processing of insurance claims is struck. The workflow engine 503 provides details on time duration required to process certain type of insurance claims.

The fraud analytics 504 comprises capability to visualize fraud in claim processing. For example, the fraud analytics 504 can show top-n (i.e. top n number of causes) cause of fraud. Also, the fraud analytics 504 shows percentage (%) figures of fraud. For example, the fraud is caused by factor-1. The fraud analytics 504 performs multi-dimensional causal analysis showing information like what kind of diseases and insured patient in the age group working in certain industry is more likely to be indulged in fraud. The fraud analytics 504 provides visualization of fraud based on behavior of the insured patient. That is, the information like what kind of behavior is more prominent in the fraud which is among certain age group and so on is provided by the fraud analytics 504.

The claim analysis 505 helps to perform analysis on types of claims. In one example, the claim analysis 505 displays what types of claim are more prominent over certain month or quarter, etc. The claim analysis 505 enables to even drill down the claim to show analytical report like what kind of claim is more prominent with different segmented data. The claim analysis 505 helps to visualize the claims which are not processed. Such way of drill down refines the claim process further and can give better experience regarding in processing the insurance claims.

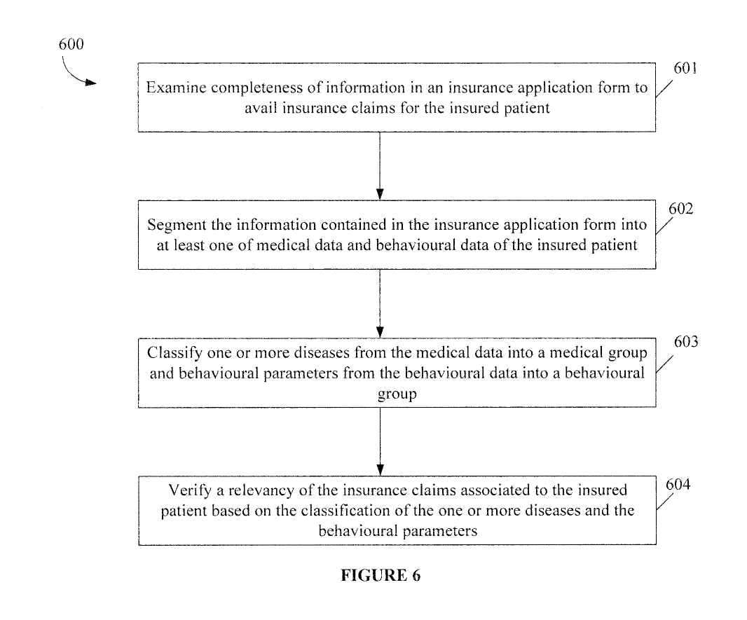

FIG. 6 illustrates a flowchart of method 600 for optimizing processing of the insurance claims for the insured patient in accordance with an embodiment of the present disclosure.

As illustrated in FIG. 6, the method 600 comprises one or more blocks for optimizing processing of the insurance claims for the insured patient performed by the insurance data processing apparatus 101. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method 600. Additionally, individual blocks may be deleted from the method 600 without departing from the scope of the subject matter described herein. Furthermore, the method 600 can be implemented in any suitable hardware, software, firmware, or combination thereof.

At block 601, the insurance data processing apparatus 101 examines completeness of information in an insurance application form to avail insurance claims for the insured patient. In an embodiment, the information is in a form which includes, but is not limited to, text, image, audio, video, and predefined templates. In an embodiment, the insurance data processing apparatus 101 alerts incompleteness of the information in the insurance application form.

At block 602, the insurance data processing apparatus 101 segments the information contained in the insurance application form into the medical data 209 and behavioural data 207 of the insured patient.

At block 603, the insurance data processing apparatus 101 classifies the one or more diseases from the medical data 209 into a medical group 214 and behavioural parameters from the behavioural data 207 into a behavioural group 215. In an embodiment, the classification is performed using the predefined one or more ontologies comprising medical ontologies 234 and behavioural ontologies 235. In insurance data processing apparatus 101 evaluates severity level of the one or more diseases suffering by the insured patient, stamina level of the insured patient, and immunity level of the insured patient using the medical ontology and historical medical information of the insured patient. The insurance data processing apparatus 101 evaluates recovery period of the insured patient using the predefined one or more ontologies, historical behavioural information and the historical medical information of the insured patient.

At block 604, the insurance data processing apparatus 101 verifies a relevancy of the insurance claims associated to the insured patient based on the classification of the one or more diseases and the behavioural parameters.

In an embodiment, the process 600 performs identifying fraud by performing retrieving reports comprising the information, the medical data, the behaviour data, historical medical information, behavioural parameters, and historical information related to availing of insurance claims. Then, the process 600 maps the reports to the at least one of the classification of the one or more diseases and the behavioural parameters and the predefined one or more ontologies to examine the correctness of availing of the insurance claims.

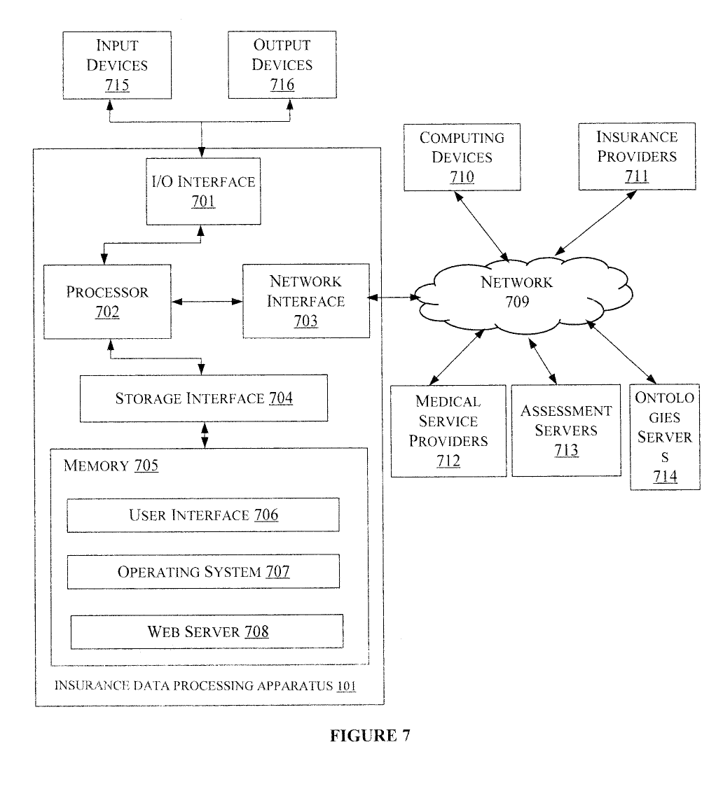

FIG. 7 illustrates a block diagram of an example of an insurance data processing apparatus 101 for implementing embodiments consistent with the present disclosure, although other types and/or numbers of other computing devices could be used. In an embodiment, the insurance data processing apparatus 101 is used to implement the insurance data processing apparatus 101. The virtual services are managed by the insurance data processing apparatus 101 to optimize processing of the insurance claims. The insurance data processing apparatus 101 may comprise a central processing unit (“CPU” or “processor”) 702. The processor 702 may comprise at least one data processor for executing program components for executing user- or system-generated information of the insured patient for claiming the insurance claims. A user may include a person, a person using a device such as such as those included in this disclosure, or such a device itself. The processor 702 may include specialized processing units such as integrated system (bus) controllers, memory management control units, floating point units, graphics processing units, digital signal processing units, etc.

The processor 702 may be disposed in communication with one or more input/output (I/O) devices (715 and 716) via I/O interface 701. The I/O interface 701 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 701, the insurance data processing apparatus 101 may communicate with one or more I/O devices (715 and 716). For example, the input device 715 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. The output device 716 may be a printer, fax machine, video display (e.g., cathode ray tube (CRT), liquid crystal display (LCD), light-emitting diode (LED), plasma, or the like), audio speaker, etc.

In some embodiments, the processor 702 may be disposed in communication with a communication network 709 via a network interface 703. The network interface 703 may communicate with the communication network 709. The network interface 703 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 709 may include, without limitation, a direct interconnection, local area network (LAN), wide area network (WAN), wireless network (e.g., using Wireless Application Protocol), the Internet, etc. Using the network interface 703 and the communication network 709, the insurance data processing apparatus 101 may communicate with one or more computing devices 710, one or more insurance providers 711, one or more medical service providers 712, one or more assessment servers 713 and one or more ontologies servers 714. The one or more computing devices 710 may include, without limitation, personal computer(s), server(s), fax machines, printers, scanners, various mobile devices such as cellular telephones, smartphones, tablet computers, eBook readers, laptop computers, notebooks, gaming consoles, or the like. In an embodiment, a business process is received from the one or more computing devices 710 which may be used by various stakeholders, medical practitioners, insurance investigators, and insurance claims approver.

In some embodiments, the processor 702 may be disposed in communication with a memory 705 (e.g., RAM, ROM, etc. not shown in FIG. 7) via a storage interface 704. The storage interface 704 may connect to memory 705 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 705 may store a collection of program or database components, including, without limitation, user interface application 706, an operating system 706, web server 708 etc. In some embodiments, insurance data processing apparatus 101 may store user/application data 706, such as the data, variables, records, etc. as described in this disclosure. Such databases may be implemented as fault-tolerant, relational, scalable, secure databases such as Oracle or Sybase.

The operating system 707 may facilitate resource management and operation of the insurance data processing apparatus 101. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the insurance data processing apparatus 101, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the insurance data processing apparatus 101 may implement a web browser 708 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the insurance data processing apparatus 101 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the insurance data processing apparatus 101 may implement a mail client stored program component. The mail client may be a mail viewing application, such as Apple Mail, Microsoft Entourage, Microsoft Outlook, Mozilla Thunderbird, etc.

Furthermore, one or more non-transitory computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure reduce manual effort in verifying and validating the information of the insured patient. Also, embodiments provide advanced technique of determining authenticity of a claim.

Embodiments of the present disclosure reduce performs risk profiling of the insurance providers based on the insured patient. The system assess the authenticity by retrieving information in real-time from social networking blogs or sites.

Embodiments of the present disclosure reduce loss to the insurance providers by analyzing on multiple dimensions like behavior, disease, etc. to come up with personalized insurance plan for the insured patient.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for optimizing processing of insurance claims, the method comprising:
examining, by an insurance data processing apparatus, completeness of information in an insurance application form to avail insurance claims for an insured patient;
segmenting, by the insurance data processing apparatus, the information contained in the insurance application form into at least one of medical data and behavioural data of the insured patient;
classifying, by the insurance data processing apparatus, one or more diseases from the medical data into a medical group and behavioural parameters from the behavioural data into a behavioural group, wherein the classification is performed using predefined one or more ontologies comprising medical ontologies and behavioural ontologies; and
verifying, by the insurance data processing apparatus, a relevancy of the insurance claims associated to the insured patient based on the classification of the one or more diseases and the behavioural parameters.

2. The method as claimed in claim 1 further comprises alerting by the insurance data processing apparatus, incompleteness of the information in the insurance application form.

3. The method as claimed in claim 1, wherein the predefined medical ontologies are generated based on relationship between different types of diseases, factors causing the diseases, severity factors of the diseases and symptoms of the diseases.

4. The method as claimed in claim 1, wherein the predefined behavioural ontologies are generated based on relationship between different behaviour of the patient along with symptoms of the behaviours, mental status of the patient, basis of occurrence of behaviour in the patient and circumstance of occurrence of behaviour in the patient.

5. The method as claimed in claim 1 further comprises evaluating by the insurance data processing apparatus, severity level of the one or more diseases suffering by the insured patient, stamina level of the insured patient, and immunity level of the insured patient using at least one of the medical ontology and historical medical information of the insured patient.

6. The method as claimed in claim 5 further comprises evaluating by the insurance data processing apparatus, recovery period of the insured patient using at least one of the predefined one or more ontologies, historical behavioural information and the historical medical information of the insured patient.

7. The method as claimed in claim 1 further comprises retrieving by the insurance data processing apparatus, behavioural parameters from one or more data sources selected from at least one of social blogs, social media, Customer Relationship Management (CRM) based data sources associated to an insurance provider, data sources associated to medical service providers, and data sources related to behavioural examiner.

8. The method as claimed in claim 1 further comprises identifying fraud, by the insurance data processing apparatus, by performing:
retrieving reports comprising at least one of the information, the medical data, the behaviour data, historical medical information, behavioural parameters, and historical information related to availing of insurance claims; and
mapping the reports to the at least one of the classification of the one or more diseases and the behavioural parameters and the predefined one or more ontologies to examine the correctness of availing of the insurance claims.

9. An insurance data processing apparatus for optimizing processing of insurance claims, comprising:
a processor;
a memory communicatively coupled to the processor, wherein the memory stores processor-executable instructions, which, on execution, cause the processor to:
examine completeness of information in an insurance application form to avail the insurance claims for an insured patient;
segment the information contained in the insurance application form into at least one of medical data and behavioural data of the insured patient;
classify one or more diseases from the medical data into a medical group and behavioural parameters from the behavioural data into a behavioural group, said classification is performed using predefined one or more ontologies comprising medical ontologies and behavioural ontologies; and
verify a relevancy of the insurance claims associated to the insured patient based on the classification of the one or more diseases and the behavioural parameters.

10. The insurance data processing apparatus as claimed in claim 9 is further configured to alert incompleteness of the information in the insurance application form.

11. The insurance data processing apparatus as claimed in claim 9, wherein the predefined medical ontologies are generated based on relationship between different types of diseases, factors causing the diseases, severity factors of the diseases and symptoms of the diseases

12. The insurance data processing apparatus as claimed in claim 9, wherein the predefined behavioural ontologies are generated based on relationship between different behaviour of the patient along with symptoms of the behaviours, mental status of the patient, basis of occurrence of behaviour in the patient and circumstance of occurrence of behaviour in the patient.

13. The insurance data processing apparatus as claimed in claim 9 is further configured to evaluate severity level of the one or more diseases suffering by the insured patient, stamina level of the insured patient, and immunity level of the insured patient using at least one of the medical ontology and historical medical information of the insured patient.

14. The insurance data processing apparatus as claimed in claim 13 is further configured to evaluate recovery period of the insured patient using at least one of the predefined one or more ontologies, historical behavioural information and the historical medical information of the insured patient.

15. The insurance data processing apparatus as claimed in claim 9 further configured to retrieve behavioural parameters from one or more data sources selected from at least one of social blogs, social media, Customer Relationship Management (CRM) based data sources associated to an insurance provider, data sources associated to medical service providers, and data sources related to behavioral examiner.

16. The insurance data processing apparatus as claimed in claim 9 is further configured to identify fraud by performing:
retrieve reports comprising at least one of the information, the medical data, the behaviour data, historical medical information, behavioural parameters, and historical information related to availing of insurance claims; and
map the reports to the at least one of the classification of the one or more diseases and the behavioural parameters and the predefined one or more ontologies to examine the correctness of availing of the insurance claims.

17. A non-transitory computer readable medium including instructions stored thereon that when processed by a processor cause an insurance data processing apparatus to perform acts of:
examining completeness of information in an insurance application form to avail the insurance claims for an insured patient;
segmenting the information contained in the insurance application form into at least one of medical data and behavioural data of the insured patient;
classifying one or more diseases from the medical data into a medical group and behavioural parameters from the behavioural data into a behavioural group, said classification is performed using predefined one or more ontologies comprising medical ontologies and behavioural ontologies; and
verifying a relevancy of the insurance claims associated to the insured patient based on the classification of the one or more diseases and the behavioural parameters.

18. The medium as claimed in claim 17, wherein the instructions further cause the processor to perform operations comprising alerting incompleteness of the information in the insurance application form.

19. The medium as claimed in claim 17, wherein the instructions further cause the processor to perform operations comprising evaluating severity level of the one or more diseases suffering by the insured patient, stamina level of the insured patient, and immunity level of the insured patient using at least one of the medical ontology and historical medical information of the insured patient.

20. The medium as claimed in claim 17, wherein the instructions further cause the processor to perform operations comprising evaluating recovery period of the insured patient using at least one of the predefined one or more ontologies, historical behavioural information and the historical medical information of the insured patient.

21. The medium as claimed in claim 17, wherein the instructions further cause the processor to perform operations comprising retrieving behavioural parameters from one or more data sources selected from at least one of social blogs, social media, Customer Relationship Management (CRM) based data sources associated to an insurance provider, data sources associated to medical service providers, and data sources related to behavioural examiner.

22. The medium as claimed in claim 17, wherein the instructions further cause the processor to perform operations comprising identifying fraud by performing:
retrieving reports comprising at least one of the information, the medical data, the behaviour data, historical medical information, behavioural parameters, and historical information related to availing of insurance claims; and
mapping the reports to the at least one of the classification of the one or more diseases and the behavioural parameters and the predefined one or more ontologies to examine the correctness of availing of the insurance claims.
